(19) United States
(12) Patent Application Publication
(10) Pub. No.: US 2013/0081090 A1
(43) Pub. Date: Mar. 28, 2013

(54) System for Mobile Phones to Provide Synchronous Broadcasting of TV Video Signals and Remote Control of TV

(71) Applicants: Shih-Pin Lin, Xiamen Torch Hi-Tech Indus. Devlp. Zone (CN); Yi-Rung HONG, Xiamen Torch Hi-Tech Indus. Devlp. Zone (CN)

(72) Inventors: Shih-Pin Lin, Xiamen Torch Hi-Tech Indus. Devlp. Zone (CN); Yi-Rung HONG, Xiamen Torch Hi-Tech Indus. Devlp. Zone (CN)

(21) Appl. No.: 13/239,638

(22) Filed: Sep. 22, 2011

(51) Int. Cl. H04N 7/16; H04W 88/02

(52) U.S. Cl. 725/62

(57) ABSTRACT

A system for mobile phones to provide synchronous broadcasting of television video signals and remote control of television adds a TV signal transmission module to a television and a remote control circuit, a mobile phone signal transmission module, a mode switch button and a mode switch circuit to a mobile phone. Therefore the mobile phone can function as a TV remote controller and also can synchronously broadcast TV video signals. Thus the system provides more flexibility and versatility than the conventional techniques.

### FIELD OF THE INVENTION

The present invention relates to a mobile phone and a television (TV in short hereinafter) hybrid system and particularly to a system to enable a mobile phone to provide synchronous broadcasting of TV video signals and remote control of TV.

### BACKGROUND OF THE INVENTION

A modern TV generally is equipped with a dedicated TV remote controller. The TV also has a built-in infrared module to receive remote control signals emitted by the remote controller. On mobile phones these days, the main stream is smart phone which not merely provides communication function also can broadcast video signals.

At present a technique combining the functions of mobile phone and remote control has been developed and is available. It adopts a principle of adding an infrared remote control module in a mobile phone. The remote control module merely links to the buttons on the mobile phone. Its main feature is placing the remote controller into the casing of the mobile phone with the buttons of the mobile phone to replace the original buttons of the remote controller. Hence the remote controller is not integrated with the operating system and the main control circuit of the mobile phone. As a result, its application scope is limited.

These days TV size becomes bigger, and most users have a coaxial cable connected to a TV input end to receive programs provided by cable TV operators. As the TV is not a mobile device, users watching TV programs often are confined in a small area in front of the TV. In the event that other matters occur while the users are watching favorable TV programs and have to go away temporarily outside the TV watching area, such as go to the lavatory, they could miss part of the on going broadcasting TV programs.

The conventional TV does not further provide solutions to solve the aforementioned problem. To provide a system that enables a mobile phone to equip functions of synchronous broadcasting TV video signals and remote control of TV is a need yet to be fulfilled.

### SUMMARY OF THE INVENTION

Therefore the primary object of the present invention is to provide a system to enable a mobile phone to provide synchronous broadcasting of TV video signals and remote control of TV. Through the system a link can be established between the mobile phone and TV so that the mobile phone can control the TV in a remote fashion, and also can broadcast TV video signals synchronously, thereby allow users to see TV programs without interruption.

To achieve the foregoing object the present invention provides a system for a mobile phone to provide synchronous broadcasting of TV video signals and remote control of TV. The system includes a TV and a mobile phone equipped with TV video signals broadcasting function. The TV has a built-in TV signal transmission module which adopts a wireless transmission technique well developed at present and a frequency band ranged from 2.4 gigahertz (GHz) to 10 GHz to maintain synchronous signal transmission between the mobile phone and TV without distortion. The transmission technique employed includes Radio Frequency, Ultra Wide Band, Bluetooth or Wireless Fidelity.

The mobile phone includes an embedded mobile phone signal transmission module which adopts a transmission technique same as the TV signal transmission module so that both can mate each other and form a wireless link between them to send and receive signals synchronously between the mobile phone and TV. The TV also has an embedded TV infrared module, and the mobile phone has a built-in remote control circuit. The remote control circuit has a mobile phone infrared module embedded inside corresponding to the TV infrared module. Hence in addition to the remote controller originally shipped with the TV, the mobile phone also can function as another TV remote controller. And the remote control circuit embedded in the mobile phone can receive the remote control commands issued by the remote controller of any TV via infrared ray.

The mobile phone of the invention also includes a mode switch circuit which is electrically connected to the remote control circuit, mobile phone signal transmission module and mobile phone main control circuit. The mode switch circuit aims to integrate synchronous broadcasting of TV video signals and remote TV control function of the mobile phone, and maintain the original communication function of the mobile phone. When a user activates the communication function operations of the remote control circuit and mobile phone signal transmission module are deactivated immediately to avoid interfering communication or operation. The TV signal transmission module of the invention can also include a tuner to provide the mobile phone with channel control and video signals broadcasting functions independent of the TV.

The system for a mobile phone to provide synchronous broadcasting of TV video signals and remote control of TV provided by the invention further enables the mobile phone to function as a universal TV remote controller and can broadcast TV video signals at the same time so that during users have to go away from the TV during watching a favorable TV program due to unpredictable events they still can continuously watch the TV program on the mobile phone without interruption. Thus the invention provides more flexibility and versatility than the conventional techniques.

The foregoing, as well as additional objects, features and advantages of the invention will be more readily apparent from the following embodiment and detailed description, which proceed with reference to the accompanying drawings.

### BRIEF DESCRIPTION OF THE DRAWINGS

FIG. 1 is a system block diagram of an embodiment of the invention.

FIG. 2 is a perspective view of an embodiment of the mobile phone of the invention.

FIG. 3 is a flowchart of an embodiment of the mobile phone of the invention in operating conditions.

### DETAILED DESCRIPTION OF THE PREFERRED EMBODIMENT

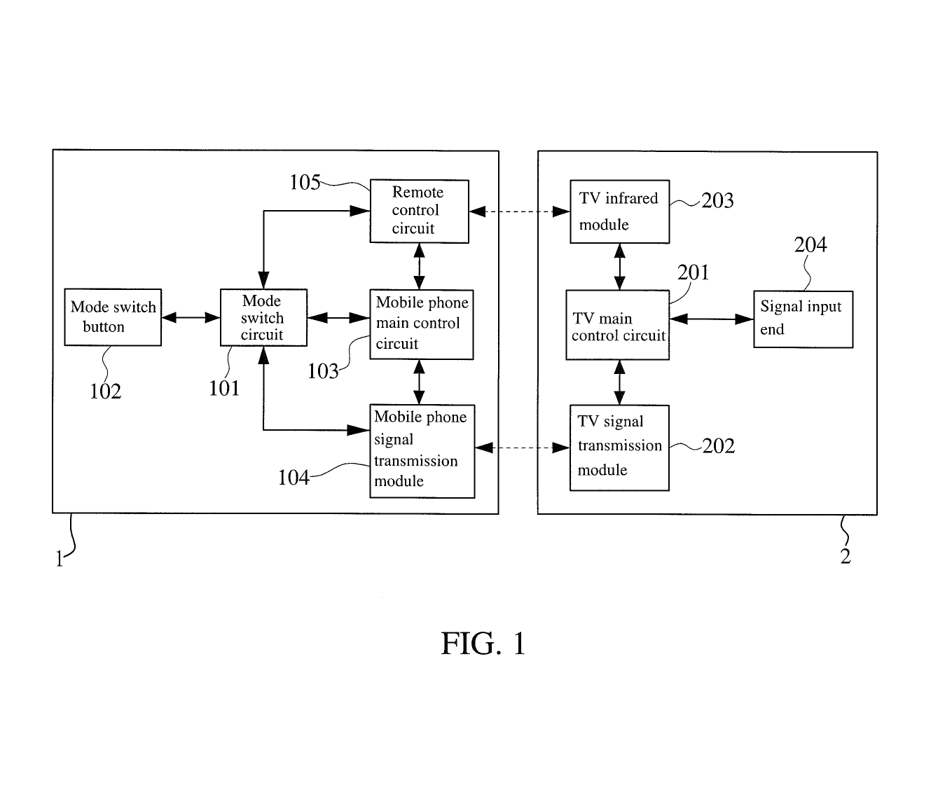

Please refer to FIG. 1 for the block diagram of an embodiment of the invention. It includes a mobile phone 1 and a TV 2. The TV 2 includes a TV main control circuit 201, a TV infrared module 203, a signal input end 204 and a TV signal transmission module 202. The TV signal transmission module 202 receives control signals sent from the mobile phone 1 and also transmits video signals to the mobile phone 1 simultaneously. The TV signal transmission module 202 can adopt a modular design and includes a USB (Universal Serial Bus) terminal to form electrical connection with the TV main control circuit 201. Such a modular design makes the TV signal transmission module 202 adaptable to various types and models of TVs. Moreover, the TV signal transmission module 202 also can include a tuner so that the mobile phone 1 can also control channels and broadcast video signals independent of the TV 2. The TV main control circuit 201 aims to process and control signals, and execute video signals broadcasting function. The TV infrared module 203 aims to receive remote control commands transmitted via infrared ray. The signal input end 204 aims to receive the video signals which include cable TV programs transmitted via a coaxial cable, radio TV programs transmitted via antennas or video signals stored in storage media such as optical disks, hard disks and the like and transmitted via TV transmission terminals.

The mobile phone 1 includes a mode switch circuit 101, a mode switch button 102, a mobile phone main control circuit 103, a mobile phone signal transmission module 104 and a remote control circuit 105. The mode switch button 102 aims to trigger and generate a mode switch signal. The mode switch circuit 101 aims to receive the mode switch signal and switch different mobile phone operation modes, and also activate or stop operation of related modules at the same time. The mobile phone operation modes include telephone mode, TV broadcasting mode and TV remote control mode. The mobile phone main control circuit 103 aims to process and control signals, and execute communication or other functions. The remote control circuit 105 has a built-in mobile phone infrared module to send remote control commands. The mobile phone transmission module 104 aims to send control signals to the TV 2 and receive at the same time the video signals sent by the TV signal transmission module 202.

The aforesaid TV signal transmission module 202 and mobile signal transmission module 104 can be linked via a wireless transmission technique, and employ bandwidth from 2.4 GHz to 10 GHz to maintain synchronous signal transmission between the mobile phone 1 and TV 2 without distortion. The wireless transmission technique can adopt Radio Frequency, Ultra Wide Band, Bluetooth or Wireless Fidelity or the like.

The mobile phone infrared module embedded in the remote control circuit 105 sends the remote control commands to the TV 2. The TV infrared module 203 receives the remote control commands. The operation principle between them is same as the TV remote controller sending the remote control commands to operate the TV 2. Moreover, the mobile phone infrared module embedded in the remote control circuit 105 is responsive to any TV set as long as the TV receives the remote control commands from external sources via infrared ray. The remote control commands sent by the remote control circuit 105 can also be processed by the mode switch circuit 101 and mobile phone main control circuit 103, then are sent by the mobile phone signal transmission module 104 and received and processed by the TV signal transmission module 202.

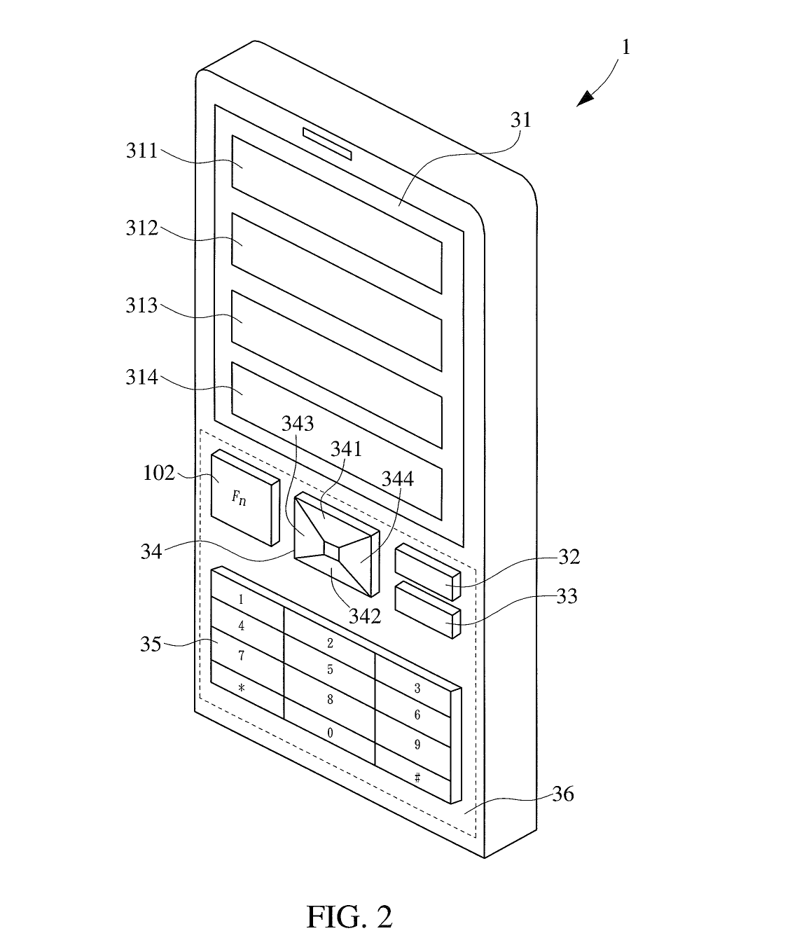

Please refer to FIG. 2 for a perspective view of an embodiment of the mobile phone of the invention. The mobile phone 1 is a smart phone and includes a mobile phone screen 31 and a key pad 36. The key pad 36 includes the mode switch button 102, a confirmation button 32, a return or cancel button 33, a direction button set 34 and a dial button set 35. The direction button set 34 includes direction button up 341, direction button down 342, direction button left 343 and direction button right 344. The mobile phone screen 31 aims to display images of the TV video signals and display requirements for users during operating the mobile phone 1. The key pad 36 aims to meet users' input requirements when the mobile phone 1 is in use by the users. The dial button set 35 also can be used to select TV channels. The direction button up 341 and direction button down 342 can also be used to switch TV channels sequentially. The direction button left 343 and direction button right 344 can also be used to adjust TV sound volume. When the TV remote control mode is activated the mode switch button 102 can also be used to activate a menu of the TV. The return or cancel button 33 can be used as a signal source button to switch various video signals received from the signal input end 204. Users also can make selection and setting via the direction button set 34 and confirmation button 32.

When the mode switch button 102 is depressed, the mobile phone screen 31 immediately displays the menu which includes a telephone mode option 311 to execute telephone modes, a TV broadcasting option 312 to execute TV broadcasting mode, a TV remote control mode option 313 to execute TV remote control mode and an advance setting option 314 to activate a sub-menu to make advanced setting. The direction button set 34, confirmation button 32 and return or cancel button 33 may also be used for selection and setting. The telephone mode is a preset mode of the mobile phone 1 to provide communication function and other functions equipped by a general smart phone. The TV broadcasting mode aims to receive the video signals sent by the TV 2 and broadcast synchronously on the mobile phone 1. The TV remote control mode aims to provide the mobile phone 1 remote control function same as a TV remote controller to control the TV 2. The advanced setting sub-menu allows the users to make advanced setting.

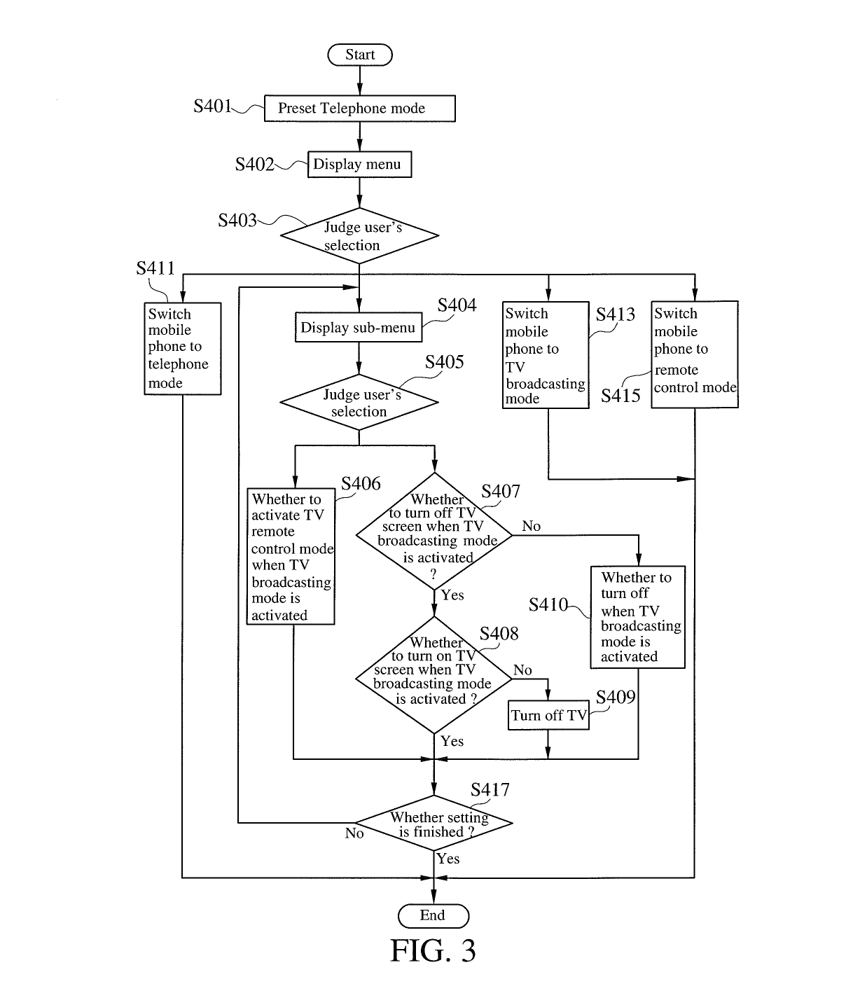

Please refer to FIG. 3 for the operation process of an embodiment of the mobile phone of the invention. When the mobile phone 1 is started, enter step S401 to execute the preset telephone mode; if user pushes the mode switch button 102, execute step S402 in which a mode switch signal is generated due to the mode switch button 102 is triggered; the mode switch circuit 101 receives the mode switch signal, through the mobile phone main control circuit 103 the mobile phone screen 31 displays the aforesaid menu; next, proceed step S403 in which the mobile phone main control circuit 103 judges user's selection; if the user selects telephone mode option 311, proceed step S411 and the operation mode of the mobile phone is switched to the telephone mode; if the user selects TV broadcasting mode option 312, proceed step S413 in which the operation mode of the mobile phone is switched to the TV broadcasting mode; if the user selects the TV remote control mode option 313, proceed step S415 in which the operation mode of the mobile phone is switched to the TV remote control mode.

In the event that the user wants to make advanced setting, then the advanced setting option 314 is selected to proceed step S404 in which the mobile phone screen 31 displays the sub-menu which includes a first sub-option to set whether the TV remote control mode is activated simultaneously when the TV broadcasting mode is activated, and a second sub-option to set whether the TV screen is turned off when the TV broadcasting mode is activated. Then proceed step 405 in which the mobile phone main control circuit 103 judges user's selection; if the user selects a first sub-option, proceed step S406 in which the mobile phone screen 31 displays a message to allow the user to select whether to activate the TV remote control mode when the TV broadcasting mode is activated; next, proceed step S417 in which the mobile phone screen 31 displays a message to ask the user whether setting is finished; if positive, the mobile phone 1 saves the setting values; if negative, return to step S404. If the user selects the second sub-option, proceed step S407 in which the mobile phone screen 31 displays a message to allow the user to determine whether to turn off the TV screen when the TV broadcasting mode is activated.

At step S407, if user's selection is positive, proceed step S408 in which the mobile phone screen 31 displays a message to allow the user to determine whether to activate the TV screen when the TV broadcasting mode is turned off. At step S408, if user's selection is positive, proceed step S417 in which the mobile phone screen 31 displays a message to ask the user whether the setting is finished; if positive, the mobile phone 1 saves the setting values; if negative, return to step S404. At step S408, if the outcome is negative, proceed step S409 in which the mobile phone turns off the TV 2 immediately when turn-off of the TV broadcasting mode is set, then proceed step S417 in which the mobile phone screen 31 displays a message to ask the user whether setting is finished, if positive, the mobile phone saves the setting values; if negative, return to step S404.

At step S407, if the outcome is negative, proceed step S410 in which the mobile phone screen 31 displays a message to allow the user to select whether to turn off TV when the TV broadcasting mode is turned off, then proceed step S417 in which the mobile phone screen 31 displays a message to ask the user whether setting is finished; if positive, the mobile phone saves the setting values; if negative, return to step S404.

When the mobile phone operation mode is the telephone mode, the mode switch circuit 101 deactivates the remote control circuit 105 and mobile phone signal transmission module 104 to protect communication of the mobile phone 1 from interference. Moreover, when the operation mode of the mobile phone 1 is TV broadcasting mode or TV remote control mode, its function of receiving in-coming phone call is not affected. When an-incoming phone call signal is received and taken by the user, the mobile phone main control circuit 103 notifies the mode switch circuit 101 to switch to the telephone mode immediately, meanwhile the remote control circuit 105 and mobile phone signal transmission module 104 are deactivated. When the user has finished the phone call, automatic switching to the previous mode takes places and the modules deactivated previously are activated again.

As previously discussed, the remote control circuit 105 can send the remote control commands to the TV infrared module 203 via infrared transmission; the remote control commands also can be sent via the mobile phone signal transmission module 104 to the TV signal transmission module 202. This mainly takes into account of the limitation of infrared transmission technique. For instance, in the event that the sending end and receiving end are blocked by an obstacle between them the infrared ray might not pass through to transmit the signal. As an example, when the user goes to the lavatory and activates the TV broadcasting mode, the mobile phone 1 can be used onsite to see the TV program at the same time. But if the lavatory and the TV 2 are blocked by walls or partitions between them, the infrared ray could be blocked and remote control of the TV 2 could be impossible, and the user cannot switch channel of the TV 2 through the mobile phone 1. In such a situation the wireless transmission techniques previously discussed can be employed to send the remote control commands via the mobile phone signal transmission module 104 to the TV signal transmission module 202 so that the user still can control the TV 2 at the remote site even being blocked by the walls or other obstacles.

As previously discussed, the TV signal transmission module 202 can also include a tuner. For instance, when the TV 2 is watched by more than one person, the person in front of the TV 2 could be seeing channel A, the user of mobile phone 1 can see channel B as desired through the tuner installed in the TV signal transmission module 202 to switch the channel without affecting the person who is watching channel A.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention set forth in the claims.

What is claimed is:

1. A system for mobile phones to provide synchronous broadcasting of television video signals and remote control of television, comprising a television and a mobile phone;
wherein the television includes:
a TV signal transmission module which employs a wireless transmission technique to receive control signals transmitted from the mobile phone and transmit synchronously video signals to the mobile phone;
a TV infrared module employed an infrared transmission technique to receive a remote control command; and
a TV main control circuit to process and control signals and execute broadcasting function of the television;
wherein the mobile phone includes:
a key pad which controls the television in a remote fashion and receives an input from a user during operating the mobile phone, and includes a mode switch button to trigger and generate a mode switch signal;
a mode switch circuit to receive the mode switch signal to switch to a telephone mode, a TV broadcasting mode or a TV remote control mode;
a mobile phone main control circuit to process and control signals and execute mobile phone communication function;
a remote control circuit including a mobile phone infrared module to transmit the remote control command;
a mobile phone signal transmission module which employs the wireless transmission technique to send the control signals to the television and receive synchronously the video signals from the television; and
a mobile phone screen to display images of the video signals of the television and display a visual output for the user during operating the mobile phone.

2. The system for mobile phones of claim 1, wherein the mobile phone screen displays a menu for the user to make selection when the mode switch button is triggered, the menu including:
a telephone mode option to use the telephone mode to provide communication and smart phone function;
a TV broadcasting option to use the TV broadcasting mode to receive the video signals sent by the television and broadcast synchronously on the mobile phone;
a TV remote control option to use the TV remote control mode to equip the mobile phone with function of a TV remote controller and control the television in a remote fashion; and
an advanced setting option to provide a sub-menu to allow the user to make advanced setting.

3. The system for mobile phones of claim 1, wherein the remote control circuit and the mobile phone signal transmission module are deactivated when the telephone mode is activated.

4. The system for mobile phones of claim 2, wherein the remote control circuit and the mobile phone signal transmission module are deactivated when the telephone mode is activated.

5. The system for mobile phones of claim 1, wherein the mode switch circuit provides receiving in-coming call function for the mobile phone in the TV broadcasting mode or TV remote control mode, and automatically switches to the telephone mode during receiving the in-coming call and automatically switches to the previous mode upon the in-coming call is finished.

6. The system for mobile phones of claim 1, wherein the remote control circuit transmits the remote control command through the mobile phone infrared module to the TV infrared module or transmits the control signals included the remote control command through the mobile phone signal transmission module to the TV signal transmission module.

7. The system for mobile phones of claim 1, wherein the remote control circuit provides remote control for any type of television.

8. The system for mobile phones of claim 6, wherein the remote control circuit provides remote control for any type of television.

9. The system for mobile phones of claim 2, wherein the sub-menu includes:
a first option to select whether to activate the TV remote control mode when the TV broadcasting mode is activated; and
a second option to select whether to turn off the TV screen when the TV broadcasting mode is activated; if positive, allowing to choose activating the TV screen or turning off the television when the TV broadcasting mode is deactivated; otherwise allowing to choose turning off the television when the TV broadcasting mode is deactivated.

10. The system for mobile phones of claim 1, wherein the wireless transmission technique employs a bandwidth ranged from 2.4 gigahertz to 10 gigahertz.

11. The system for mobile phones of claim 1, wherein the wireless transmission technique employs Radio Frequency, Ultra Wide Band, Bluetooth or Wireless Fidelity.

12. The system for mobile phones of claim 10, wherein the wireless transmission technique employs Radio Frequency, Ultra Wide Band, Bluetooth or Wireless Fidelity.

13. The system for mobile phones of claim 1, wherein the TV signal transmission module includes a built-in tuner to provide the mobile phone channel control and video signals broadcasting functions independent of the television.

14. The system for mobile phones of claim 6, wherein the TV signal transmission module includes a built-in tuner to provide the mobile phone channel control and video signals broadcasting functions independent of the television.
